(19) United States
(12) Patent Application Publication
(10) Pub. No.: US 2014/0263940 A1
(43) Pub. Date: Sep. 18, 2014

(54) SUPPORTING MECHANISM FOR PORTABLE ELECTRONIC DEVICE

(71) Applicants: FIH (Hong Kong) Limited, Kowloon (HK); SHENZHEN FUTAIHONG PRECISION INDUSTRY CO., LTD., Shenzhen (CN)

(72) Inventors: Hai-Qiang Wang, Shenzhen (CN); Yao Wang, Shenzhen (CN); Yi-Lung Chen, New Taipei (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/960,748

(22) Filed: Aug. 6, 2013

(30) Foreign Application Priority Data
Mar. 14, 2013 (CN) 2013100812917

(51) Int. Cl. F16M 13/00

(52) U.S. Cl. CPC F16M 13/005
USPC 248/688

(57) ABSTRACT

A supporting mechanism for holding a portable electronic device includes a main body, a supporting member, and a supporting assembly. The main body is configured for receiving the portable electronic device and defining a number of guiding slots and a central hole communicating with the number of guiding slots. The supporting member is receivable in the central hole. The supporting assembly is rotatably connected to the supporting member and slidably receivable in the number of guiding slots. When the supporting member is pulled out of the central hole by an external force, the supporting assembly slides in the number of guiding slots and is positioned at a predetermined position of the number of guiding slots.

### BACKGROUND

1. Technical Field

The disclosure generally relates to supporting mechanisms and more particularly to a supporting mechanism for holding portable electronic devices in a predetermined position.

2. Description of the Related Art

There are many supporting mechanisms available for supporting portable electronic devices at a particular angle to allow hands-free viewing of display screen. However, such supporting mechanisms often have a complex structure and are inconvenient to carry when also carrying the electronic device.

Therefore, there is room for improvement within the art.

### BRIEF DESCRIPTION OF THE DRAWINGS

Many aspects of an exemplary supporting mechanism can be better understood with reference to the following drawings. The components in the drawings are not necessarily drawn to scale, the emphasis instead being placed upon clearly illustrating the principles of the exemplary supporting mechanism. Moreover, in the drawings, like reference numerals designate corresponding parts throughout the several views. Wherever possible, the same reference numbers are used throughout the drawings to refer to the same or like elements of an embodiment.

FIG. 1 is an exploded view of a supporting mechanism, according to an exemplary embodiment the supporting mechanism including a guiding groove, a supporting member, and a supporting assembly.

FIG. 2 is an enlarged view of the guiding groove shown in FIG. 1.

FIG. 3 is a cross section view of the guiding grooves shown in FIG. 2.

FIG. 4 is a schematic view of the supporting member and the supporting assembly shown in FIG. 1.

FIG. 5 is an enlarged view of a circular part V shown in FIG. 1.

FIG. 6 is an assembled view of the supporting mechanism shown in FIG. 1.

FIG. 7 is similar to FIG. 6, but shown from another angle.

FIG. 8 is similar to FIG. 7, but shown in another state of use.

### DETAILED DESCRIPTION

FIG. 1 shows a supporting mechanism 100 for holding a portable electronic device, such as a tablet computer, a mobile phone, or an electronic book. The supporting mechanism 100 includes a main body 10, a supporting member 30, and a supporting assembly 50. The supporting member 30 and the supporting assembly 50 are attached to the main body 10.

The main body 10 has a shape similar to the portable electronic device and is configured for receiving the portable electronic device. In the embodiment, the main body 10 is substantially a rectangular plate, and a flange 12 extends from each of two opposite edges of the main body 10. The main body 10 defines an X-shaped through hole (not labeled). The through hole can be considered to have five parts, four arms of the through hole, referred to as guiding slots 14, and the intersection of the four arms, referred to as a central hole 16. Referring to FIG. 2 and FIG. 3, each sidewall of each guiding slot 14 defines a guiding groove 140. Each guiding groove 140 defines a receiving recess 141, a first latching recess 142, and a second latching recess 143. The receiving recess 141 and the second latching recess 143 are respectively located at two ends of the guiding groove 140. The first latching recess 142 is located adjacent to the second latching recess 143.

Also referring to FIG. 4 and FIG. 6, the supporting member 30 is receivable in the central hole 16 and can be pulled out of the central hole 16. The supporting member 30 includes a central body 32 having four securing portions 34 extending from the sides of the central body 32. The central body 32 and the four securing portions 34 are coplanar. Opposite pairs of the securing portions 34 are symmetrically arranged. When the central body 32 is received in the central hole 16, each securing portion 34 is received in a corresponding guiding slot 14. A distal end of each securing portion 34 defines a notch 340 and two opposite through holes 342 communicating with the notch 340. A concave portion 360 is defined adjacent an intersection of the central body 32 and each securing portion 34 for allowing the supporting member 30 to be easily pulled out of the central hole 16 through the concave portions 360.

Referring to FIG. 4, the supporting assembly 50 is made of four sliding members 52 corresponding to one of the four securing portions 34. Each sliding member 52 includes a main portion 520, two latching members 542, a pivot portion 526 extending from an end of the main portion 520, and a shaft 528. The main portion 520 has a shape similar to the guiding slot 14 for being receivable in the guiding slot 14. The two latching members 542 are respectively located on two opposite edgewalls of the main portion 520 and are oriented away from the pivot portion 526. Each latching member 542 includes an L-shaped bent portion 5421 and an arcuate portion 5423 connected to the bent portion 5421. The arcuate portion 5423 corresponds to the first latching recess 142, and the second latching recess 143. In the embodiment, the latching member 542 is a steel wire. Each of the two opposite edgewalls of the main portion 520 defines a locking hole 522 for rotatably receiving the bent portion 5421 to allow the main portion 520 to move with the latching member 542 together. The main portion 520 can rotate relative to the latching members 542. The pivot portion 526 defines a shaft hole 5260, and the shaft 528 is rotatably received in the shaft hole 5260. The pivot portion 526 is engaged in the notch 340, and the shaft hole 5260 is aligned with the through holes 342. The shaft 528 extends through the through holes 342 and the shaft hole 5260 for allowing the pivot portion 526 to rotate relative to the securing portion 34.

Also referring to FIG. 6 to FIG. 7, the assembly process of the supporting mechanism 100 is as follows:

The bent portion 5421 of each latching member 542 is inserted into the locking hole 522 to attach the latching member 542 to the main portion 520. Each sliding member 52 is rotatably connected to its corresponding securing portion 34 by the shaft 528. The supporting assembly 50 and the four securing portions 34 of the supporting member 30 are received in the four guiding slots 14, and the central body 32 of the supporting member 30 is received in the central hole 16. Each latching member 542 is located in the corresponding guiding groove 140 and received in the receiving recess 141, and then the sliding member 52 can be slid along the guiding groove 140 by the latching member 542.

FIG. 8 shows a use state of the supporting mechanism 100. The central body 32 of the supporting member 30 is pulled out of the central hole 16 by an external force, for example, a user pulls the central body 32 grasping the concave portions 360. The securing portion 34 drives the corresponding sliding member 52 to slide in the guiding slot 14. The latching member 542 slides out of the receiving recess 141 and slides in the guiding groove 140 until the arcuate portion 5423 slides into the first latching recess 142.

Then the supporting member 30 and the supporting assembly 50 support the main body 10 together, and the supporting mechanism 100 can be stably placed on a flat surface, such as a desktop. If the user keeps on pulling the central body 32, the latching member 542 slides out of the first latching recess 142 and slides into the second latching recess 143 to adjust the angle between the main body 10 and the supporting assembly 50.

When the supporting member 30 is pushed toward the main body 10 by an external force, the arcuate portion 5423 slides out of the first latching recess 142, and the sliding member 52 slides in the guiding slot 14 until the sliding member 52 is completely received in the guiding slot 14.

The supporting mechanism 100 can be stably placed on a flat surface supported the supporting member 30 and the supporting assembly 50. The supporting member 30 and the supporting assembly 50 can be received in the main body 10, and then the supporting mechanism 100 is convenient to carry.

In another exemplary embodiment, the latching member 542 is a protrusion.

In another exemplary embodiment, the first latching recess 142 is defined in the main portion 520, and the latching member 542 is located in the guiding groove 140.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A supporting mechanism for holding a portable electronic device, the supporting mechanism comprising:
a main body configured for receiving the portable electronic device and defining a plurality of guiding slots and a central hole, the plurality of guiding slots communicating with the central hole;
a supporting member receivable in the central hole; and
a supporting assembly rotatably connected to the supporting member and slidably receivable in the plurality of guiding slots;
wherein when the supporting member is pulled out of the central hole by an external force, the supporting assembly slides in the plurality of guiding slots and is positioned at a predetermined position of the plurality of guiding slots.

2. The supporting mechanism as claimed in claim 1, wherein the supporting member comprises a central body having a plurality of securing portions extending from the sides of the central body, the central body is receivable in the central hole, the plurality of securing portions are connected to the supporting assembly and are respectively receivable in the plurality of guiding slots.

3. The supporting mechanism as claimed in claim 2, wherein a concave portion is defined adjacent an intersection of the central body and the securing portion.

4. The supporting mechanism as claimed in claim 2, wherein a distal end of the securing portion defines a notch and two opposite through holes communicating with the notch.

5. The supporting mechanism as claimed in claim 4, wherein the supporting assembly comprises a plurality of sliding member corresponding to the plurality of securing portions, each sliding member comprises a main portion, two latching members, a pivot portion extending from an end of the main portion and a shaft; the two latching members are respectively located on two opposite edgewalls of the main portion and are oriented away from the pivot portion; the pivot portion defines a shaft hole, and the shaft is received in the shaft hole.

6. The supporting mechanism as claimed in claim 5, wherein the pivot portion is engaged with the notch, and the shaft hole is aligned with the through holes, the shaft extends through the through holes and the shaft hole, and the pivot portion is rotatably connected to the securing portion.

7. The supporting mechanism as claimed in claim 6, wherein the latching member comprises a bent portion and an arcuate portion connected to the bent portion; each of the two opposite edgewalls of the main portion defines a locking hole engaged with the bent portion, the main portion is rotatably connected to the latching member.

8. The supporting mechanism as claimed in claim 7, wherein the latching member is a steel wire.

9. The supporting mechanism as claimed in claim 5, wherein two opposite edgewalls of each guiding slot defines a guiding groove, and each guiding groove defines a latching recess; each sliding member slides in one guiding slot until the latching member slides into the latching recess.

10. The supporting mechanism as claimed in claim 1, wherein a flange extends from each of two opposite edges of the main body.

11. A supporting mechanism for a portable electronic device, the supporting mechanism comprising:
a main body configured for receiving the portable electronic device and defining four guiding slots and a central hole, each of the four guiding slots communicating with the other three guiding slots, an intersection of the four guiding slots is defined as the central hole;
a supporting member receivable in the central hole; and
a supporting assembly rotatably connected to the supporting member and slidably receivable in the four guiding slots;
wherein when the supporting member is pulled out of the central hole by an external force, the supporting assembly slides in the four guiding slots and is positioned at a predetermined position of the four guiding slots.

12. The supporting mechanism as claimed in claim 11, wherein the supporting assembly comprises four sliding members respectively slidably receivable in the four guiding slots; each sliding member comprises a latching member, and each guiding slot defines a latching recess; when the supporting member is pulled out of the central hole by an external force, the four sliding members slides in the four guiding slots until the latching member slides into the latching recess.

13. The supporting mechanism as claimed in claim 12, wherein two opposite edgewalls of each guiding slot defines a guiding groove, and each guiding groove defines the latching recess.

14. The supporting mechanism as claimed in claim 13, wherein the supporting member comprises a central body having four securing portions extending from the sides of the central body, the central body is receivable in the central hole, each securing portion is connected to one of the four sliding members and is receivable in one of the four guiding slots.

15. The supporting mechanism as claimed in claim 14, wherein a concave portion is defined adjacent an intersection of the central body and each securing portion.

16. The supporting mechanism as claimed in claim 14, wherein a distal end of each securing portion defines a notch and two opposite through holes communicating with the notch.

17. The supporting mechanism as claimed in claim 16, wherein each sliding member comprises a main portion, two latching members, a pivot portion extending from an end of the main portion and a shaft; the two latching members are respectively located on two opposite edgewalls of the main portion and are oriented away from the pivot portion; the pivot portion defines a shaft hole, and the shaft is received in the shaft hole.

18. The supporting mechanism as claimed in claim 17, wherein the pivot portion is engaged with the notch, and the shaft hole is aligned with the through holes, the shaft extends through the through holes and the shaft hole, and the pivot portion is rotatably connected to the securing portion.

19. The supporting mechanism as claimed in claim 18, wherein each latching member comprises a bent portion and an arcuate portion connected to the bent portion; each of the two opposite edgewalls of the main portion defines a locking hole engaged with the bent portion, the main portion is rotatably connected to the two latching members.

20. The supporting mechanism as claimed in claim 19, wherein the latching member is a steel wire.
